(19) United States
(12) Patent Application Publication
(10) Pub. No.: US 2005/0260522 A1
(43) Pub. Date: Nov. 24, 2005

(54) Permanent resist composition, cured product thereof, and use thereof

(76) Inventors: William Weber, East Providence, RI (US); Satoshi Mori, Tokyo (JP); Nao Honda, Saitama-shi (JP); Donald Johnson, Wayland, MA (US); Manuel DoCanto, Stoughton, MA (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/054,651

(22) Filed: Feb. 9, 2005

Related U.S. Application Data
(60) Provisional application No. 60/544,403, filed on Feb. 13, 2004.

(51) Int. Cl. G03C 1/492

(52) U.S. Cl. 430/270.1

(57) ABSTRACT

A permanent photoresist composition comprising: (A) one or more bisphenol A-novolac epoxy resins according to Formula I; wherein each group R in Formula I is individually selected from glycidyl or hydrogen and k in Formula I is a real number ranging from 0 to about 30; (B) one or more epoxy resins selected from the group represented by Formulas BIIa and BIIb; wherein each R₁, R₂ and R₃ in Formula BIIa are independently selected from the group consisting of hydrogen or alkyl groups having 1 to 4 carbon atoms and the value of p in Formula BIIa is a real number ranging from 1 to 30; the values of n and m in Formula BIIb are independently real numbers ranging from 1 to 30 and each R₄ and R₅ in Formula BIIb are independently selected from hydrogen, alkyl groups having 1 to 4 carbon atoms, or trifluoromethyl; (C) one or more cationic photoinitiators (also known as photoacid generators or PAGs); and (D) one or more solvents.

### CROSS-REFERENCE TO RELATED APPLICATIONS

This application claims the benefit of U.S. Provisional Application No. 60/544,403 filed Feb. 13, 2004, which is incorporated by reference in its entirety.

### BACKGROUND OF THE INVENTION

1. Field of the Invention

This invention relates to photoimageable epoxy resin compositions and the permanent cured products thereof, that are useful in the fabrication of MEMS (micro-electromechanical system) components, micromachine components, microfluidic components, μ-TAS (micro total analytical system) components, ink-jet printer components, microreactor components, electroconductive layers, LIGA components, forms and stamps for microinjection molding and hot embossing, screens or stencils for fine printing applications, MEMS and semiconductor packaging components, BioMEMS and biophotonic devices, and printed wiring boards that can be processed by ultraviolet (UV) lithography or imprinted using hot embossing.

2. Brief Description of Art

Photoimageable coatings are currently used in a wide variety of semiconductor and micromachining applications. In such applications, photoimaging is accomplished by exposing the coating on a substrate to patterned radiation thereby inducing a solubility change in the coating such that the exposed or unexposed regions can be selectively removed by treatment with a suitable developer composition. The photoimageable coating (photoresist) may be either of the positive or negative type, where exposure to radiation either respectively increases or decreases the solubility in the developer. Advanced electronic packaging applications requiring high density interconnects with a high aspect ratio (defined as the height to width ratio of the imaged feature), or applications involving the fabrication of micro-electromechanical devices (MEMS) often require photoimageable layers capable of producing uniform spin-coated films and high aspect ratio images with vertical sidewall profiles in films with a thickness greater than one hundred microns.

Conventional positive resists based on diazonaphthoquinone-novolac chemistry are not well-suited to applications requiring film thicknesses greater than about 50 microns. This thickness limitation is caused by the relatively high optical absorbance of the diazonaphthaquinone-type (DNQ) photoactive compounds at wavelengths in the near-ultraviolet region of the optical spectrum (350-450 nm) which are typically used to expose the resist. Also, DNQ-type photoresists possess limited contrast, or differential solubility, of the exposed vs. unexposed resist in a developer solution which results in relief image sidewalls that are sloped rather than vertical. Optical absorption necessarily reduces the radiation intensity as it traverses from the top to the bottom of the film, such that if the optical absorption is too high, the bottom of the film will be underexposed relative to the top, causing a sloped or otherwise distorted profile of the developed image. Nevertheless, DNQ photoresist formulations are available for use at film thicknesses up to 100 microns, but at the expense of greatly increased exposure dose and reduced side wall angle.

A negative, spin-coated, thick-film photoimageable composition of the chemically amplified type, which has a very low optical absorbance at wavelengths in the 350-450 nm range has been described in the literature [N. LaBianca and J. D. Gelorme, “High Aspect Ratio Resist for Thick Film Applications”, Proc. SPIE, vol. 2438, p. 846 (1995)]. High aspect ratio (>10:1) photoimaging was demonstrated in 200 micron thick films. This resist comprises a solution in a casting solvent of a highly branched, multifunctional epoxy bisphenol A-novolac resin, EPON® SU-8 from Resolution Performance Products, Houston, Tex., and a photoacid generator (PAG) such as CYRACURE® UVI 6974 from Dow Chemical, Midland, Mich., which consists of a solution of arylsulfonium hexafluoroantimonate salts in propylene carbonate as solvent. The resulting photoresist formulation may be spin coated or curtain coated onto a wide variety of substrates, baked to evaporate solvent, leaving a solid photoresist coating of one hundred microns or greater thickness which may be photoimaged by exposure to near-ultraviolet radiation through a patterned photomask using contact, proximity, or projection exposure methods. Subsequent immersion of the imaged layer in a developer solution dissolves the unexposed regions, leaving behind a high resolution, negative-tone relief image of the

EPON® SU-8 resin is a low molecular weight epoxy-functional oligomer that has several characteristics making it advantageous for high aspect ratio photoimaging in thick films: (1) it has a high average epoxide functionality, (2) a high degree of branching, (3) high transparency at wavelengths of 350-450 nm, and (4) the molecular weight is sufficiently low as to allow preparation of high solids coating compositions. The high functionality and branching result in efficient crosslinking under the influence of strong acid catalysts, while the high transparency allows uniform irradiation through thick films, making the resist capable of forming images with aspect ratio of greater than 10:1 at film thicknesses of greater than 100 microns. Selection of resins with high epoxy functionality and a high degree of branching is an important consideration for providing high aspect ratio structures with straight sidewalls. Selection of resins with low molecular weight permits preparation of high solids coatings allows thick photoresist films to be formed on a substrate with a minimum number of coating steps.

Suitable photoacid generators (PAGs) based on sulfonium or iodonium salts are well-known and have been extensively discussed in the literature [see for example. Crivello et al., “Photoinitiated Cationic Polymerization with Triarylsulfonium Salts”, Journal of Polymer Science: Polymer Chemistry Edition, vol. 17, pp. 977-999 (1979).] Other useful PAGs with appropriate absorbance include the carbonyl-p-phenylene thioethers as described in U.S. Pat. Nos. 5,502,083 and 6,368,769 B1. Additionally, sensitizers such as 2-alkyl-9,10-dimethoxyanthracenes or various other anthracene, naphthalene, peryl or pyryl compounds can be added to the formulation or incorporated into the PAG as described in U.S. Pat. No. 5,102,772.

Negative photoresists based on the above disclosed compositions which are suitable for spin-coating are sold by MicroChem Corp., Newton, Mass., USA and are used commercially, especially in the fabrication of MEMS devices. For example, a product typically offered by MicroChem, “SU-8 50” can be spin-coated at 1000-3000 rpm to produce films of thickness in the range of 30-100 microns which can, after exposure and development, produce images having an aspect ratio greater than 10:1 at film thicknesses greater than 100 microns. Higher or lower solids versions extend the film thickness range obtainable by a single coat process to less than 1 micron and above 200 microns. Casting of the solution can result in films of 1 to 2 mm or more in thickness. U.S. Pat. No. 4,882,245 also describes the application of these materials as a dry film photoresist when coated onto a carrier medium such as polyester film.

While the SU-8 resin based compositions disclosed are capable of very high resolution and aspect ratio, the cured resin by itself has a tendency to be too brittle for some applications, and often undergoes developer induced crazing/cracking, stress-induced cracking, has limited adhesion to certain substrates, and sometimes demonstrates delamination of the coating from the substrate. All these problems are exacerbated by the shrinkage-induced stress that occurs when the material undergoes polymerization and is manifested in substrate bowing, where the shrinkage of the coating induces bending (bowing) of the substrate.

U.S. Pat. Nos. 4,882,245 and 4,940,651 disclose a photoimageable cationically polymerizable composition for use in printed circuit boards which consists of a mixture of up to 88% epoxidized bisphenol A formaldehyde novolac resin with average epoxide functionality of eight and a reactive diluent which serves as a plasticizer, and a cationic photoinitiator. Reactive diluents disclosed were mono- or difunctional cycloaliphatic epoxides, preferably at 10-35% by weight solids. Also disclosed are the use of these formulations as permanent layers, where the layer is not removed from the substrate, but becomes a part of the structure, such as a dielectric layer on a printed circuit board.

U.S. Pat. Nos. 5,026,624, 5,278,010, and 5,304,457 disclose a photoimageable, cationically polymerizable fire retardant composition suitable for use as a solder mask, which consists of a mixture of the 10-80% condensation product of bisphenol A and epichlorohydrin, 20-90% of epoxidized bisphenol A formaldehyde novolac resin, and 35-50% by weight of epoxidized glycidyl ether of tetrabromobisphenol A, with 0.1-15 parts per hundred by weight of a cationic photoinitiator. Curtain coating, roll coating, and wound wire rod coating were used.

U.S. Pat. No. 4,256,828 discloses a photopolymerizable composition based on an epoxy resin of functionality greater than 1.5, a hydroxyl-containing additive, and a photoacid generator. The hydroxyl-containing additive is reported to increase flexibility and decrease shrinkage for coatings of up to 100 microns in thickness.

U.S. Pat. No. 5,726,216 describes a toughened epoxy resin system and the methods for making and using such a system in electron beam radiation curable applications. The main difficulty they claim to overcome is the brittleness of the radiation cured epoxy resins where the resins for many structural, non-structural or other consumer products must have sufficient toughness and impact resistance to endure many years of harsh service. They disclose a wide variety of toughening agents that can be incorporated into the base epoxy resin or mixture, which may include SU-8 resin. Effectiveness of the claimed invention with respect to increased toughness was measured by fracture toughness and flexural modulus. The toughening agents claimed constitute a variety of thermoplastics, hydroxy-containing thermoplastic oligomers, epoxy-containing thermoplastic oligomers, reactive flexibilizers, elastomers, rubbers, and mixtures thereof. However, the compositions of U.S. Pat. No. 5,726,216 were formulated as coatings imaged with non-patterned electron beam radiation and no reference was made to the photoimaging characteristics of these formulations when exposed to imaged ultraviolet, X-ray, or electron beam radiation.

There have been many other prior art proposals for different photoimageable compositions including many that use epoxies. Examples of these can be found as referenced in U.S. Pat. No. 5,264,325. Here it is further taught that the resist material must be formulated such that it can be applied by coating methods, for example spin coating, which requires certain Theological properties. In addition, the composition must have the properties of providing sufficient transmission of the exposing radiation so as to photolyze the photoinitiator through the thickness of the film, and the resist must possess appropriate physical and chemical properties to withstand the application, such as solder or ink resistance or toughness, without significant degradation, or loss of adhesion. If the photoresist composition is to be used for other purposes, such as an etch photoresist, other properties may be required. No specific type of epoxy resin has been found which will satisfy all of the various requirements; however many different combinations or mixtures of various epoxy resins have been disclosed. All of the noted patents describe various resins and photoinitiators for use in photocurable compositions, many of which may be useful as photoimageable layers in permanent applications. However none of them teach or suggest the specific composition of the present invention nor are they suitable for our intended applications. Virtually all of the examples of plasticizers, flexibilizers and tougheners degrade the lithographic performance of the system.

It is therefore desirable to provide a photoimageable, cationically-cured, composition containing epoxy resins which retains the good image resolution, thermal stability, chemical and solvent resistance characteristics of SU-8 based formulations but at the same time improves performance with respect to adhesion, delamination, cracking, crazing, stress, and flexibility characteristics.

### BRIEF SUMMARY OF THE INVENTION

The present invention relates to selected photoimageable epoxy resin compositions and the permanent cured products thereof that are useful in the fabrication of MEMS (micro-electromechanical system) components, micromachine components, μ-TAS (micro-total analytical system) components, microreactor components, dielectric layers, insulation layers, photoconductive waveguides, ink jet printer head parts, BioMEMS and biophotonic devices, and the like that are capable of being worked by ultraviolet ray lithography. The invention further relates to selected uncured resist compositions and the cured products thereof in which the cured product has high strength, excellent adhesion, improved flexibility, resistance to cracking and crazing, excellent chemical resistance to acids, bases, and solvents, alkali resistance, good heat resistance, and good electrical properties.

Therefore, one aspect of the present invention is directed to photoresist compositions useful for making negative-tone, permanent photoresist layers comprising:
(A) one or more bisphenol A-novolac epoxy resins according to Formula I; wherein 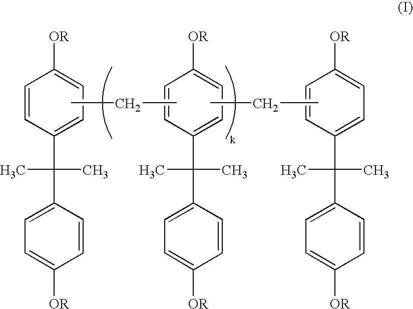
each group R in Formula I is individually selected from glycidyl or hydrogen and k in Formula I is a real number ranging from 0 to about 30;
(B) one or more epoxy resins selected from the group represented by Formulas BIIa and BIIb; 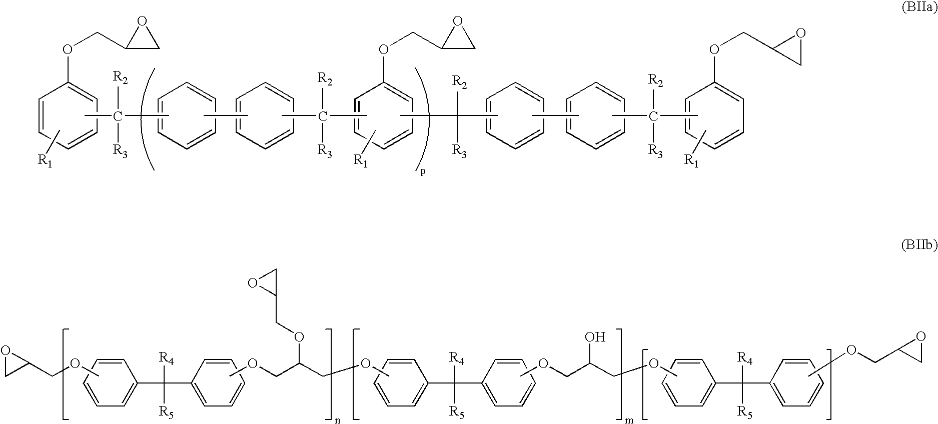
   wherein each R₁, R₂ and R₃ in Formula BIIa are independently selected from the group consisting of hydrogen or alkyl groups having 1 to 4 carbon atoms and the value of p in Formula BIIa is a real number ranging from 1 to 30; the values of n and m in Formula BIIb are independently real numbers ranging from 1 to 30 and R₄ and R₅ in Formula BIIb are independently selected for the group consisting of hydrogen, alkyl groups having 1 to 4 carbon atoms, or trifluoromethyl;
(C) one or more cationic photoinitiators (also known as photoacid generators or PAGs); and
(D) one or more solvents.

In addition to components (A) through (D) inclusively, the composition according to the invention can optionally comprise one or more of the following additive materials: (E) one or more optional epoxy resins; (F) one or more reactive monomers; (G) one or more photosensitizers; (H) one or more adhesion promoters: (J) one or more light absorbing compounds including dyes and pigments; and (K) one or more organoaluminum ion-gettering agents. In addition to components (A) through (K) inclusively, the composition according to the invention can also optionally comprise additional materials including, without limitation, flow control agents, thermoplastic and thermosetting organic polymers and resins, inorganic filler materials, radical photoinitiators, and surfactants.

Still another aspect of the present invention is directed to a method of forming a permanent photoresist pattern comprising: the process steps of: (1) applying any of the photoresist compositions according to the invention to a substrate; (2) evaporating most of the solvent by heating the coated substrate to form a film of the composition on the substrate; (3) irradiating the film on a substrate by active rays through a mask; (4) crosslinking the irradiated film segments by heating; (5) developing the image in the film with a solvent to form a negative-tone relief image of the mask in the photoresist film; and optionally; (6) heat-treating the developed photoresist film to complete crosslinking, increase the density of the film, and improve adhesion of the film to the coated substrate.

Another aspect of the present invention is directed to a dry film resist composition made from any of the photoresist compositions according to the invention wherein the dry film photoresist comprises a substantially dried coating of the photoimageable composition coated on a flexible carrier film.

Yet another aspect of the present invention is directed to a method of forming a photoresist pattern comprising the process steps of: (1) laminating the dry film photoresist according to the invention to a substrate; (2) peeling or otherwise removing the base film carrier film from the substrate; (3) image-wise exposing the photoresist film on the substrate by irradiation with active rays through a mask; (4) crosslinking the irradiated film segments by means of a post exposure bake; (5) developing the image in the film with a solvent to form a negative relief image of the mask in the photoresist film; and optionally, (6) heat-treating the developed photoresist film to complete crosslinking and densification of the film. Optionally, the carrier film may be peeled or otherwise removed from the laminated substrate after the exposure step or after the post exposure bake step.

Another aspect of the present invention is directed to the cured and permanent layers formed on a substrate or between two substrates that results from applying a heat treatment to either a substantially dried film of the composition on a substrate or a substantially dried film of the composition on a substrate that has been treated with ultraviolet, x-ray, or e-beam radiation wherein the radiation is applied by direct irradiation of the coated substrate or by image-wise irradiation of the coated substrate through a photomask pattern.

Another aspect of the present invention is directed to a method of forming a permanent photoresist pattern comprised of embossing, imprinting, microimprinting, or nanoimprinting the uncured film of the photoresist composition on a substrate under the action of heat and pressure to cure the photoresist into an imprinted relief image with said imprinted and cured photoresist forming a permanent patterned layer on the substrate. The uncured film can be either non-imagewise exposed with active rays prior to the imprint process or the temperature of the imprint process can be such that the cationic photoinitiator is decomposed by heat causing a subsequent chemical reaction that cross links the film.

### DETAILED DESCRIPTION OF THE INVENTION

In the art related to photoimageable compositions, photoresists are generally understood to be temporary coatings that are used to selectively protect one area of a substrate from another such that the operation of a subsequent process takes place only in an area of the substrate that is not covered by the photoresist. Once this subsequent operation has been completed, the photoresist is removed. Thus, the properties of such temporary photoresists need only be those required to obtain the required image profile and be resistant to the action of the subsequent process steps. However, the present invention also addresses applications wherein the photoresist layer is not removed and is used as a permanent structural component of the device being fabricated. In the case of use of the photoresist as a permanent layer, the material properties of the photoresist film must be compatible with the intended function and end use of the device. Therefore, photoimageable layers that remain as a permanent part of the device are termed herein as permanent photoresists.

The permanent photoresist composition of the present invention is comprised of: a bisphenol A novolac epoxy resin (A); one or more epoxy resins (B) represented by general Formulas BIIa and BIIb; one or more cationic photoinitiators (C); and one or more solvents (D) as well as optional additives.

Bisphenol A novolac epoxy resin (A) suitable for use in the present invention can be obtained by reacting a bisphenol A novolac resin and epichlorohydrin. Resins having a weight average molecular weight ranging from 2000 to 11000 are preferred and resins with a weight average molecular weight ranging from 4000 to 7000 are particularly preferred. Epicoat® 157 (epoxide equivalent weight of 180 to 250 grams resin per equivalent of epoxide (g resin/eq or g/eq) and a softening point of 80-90° C.) made by Japan Epoxy Resin Co., Ltd. Tokyo, Japan, and EPON® SU-8 Resin (epoxide equivalent weight of 195 to 230 g/eq and a softening point of 80 to 90° C.) made by Resolution Performance Products, Houston, Tex. and the like are cited as preferred examples of bisphenol A novolac epoxy resins suitable for use in the present invention.

Epoxy resins (B) according to Formulas (BIIa) and (BIIb) are flexible and strong and are capable of giving these same properties to the pattern that is formed. An example of the epoxy resin (BIIa) used in the present invention are the epoxy resins according to Japanese Kokai Patent No. Hei 9(1997)-169,834 that can be obtained by reacting di(methoxymethylphenyl) and phenol and then reacting epichlorohydrin with the resin that is obtained. An example of a commercial epoxy resin according to Formula IIa is epoxy resin NC-3000 (epoxide equivalent weight of 270 to 300 g/eq and a softening point of 55 to 75° C.) made by Nippon Kayaku Co., Ltd. Tokyo, Japan, and the like are cited as examples. It should be noted that the preferred value of n in Formula BIIa is calculated by an inverse operation from the epoxy equivalent of epoxy resin (BIIa), and a preferred number of 1 or higher, more preferably a number of 1 to 10, is the average value. It is to be understood that more than one epoxy resin according to Formula BIIa can be used in the compositions according to the invention.

The epoxy resins of Formula BIIb may be obtained by reaction of the alcoholic hydroxyl groups of bisphenol-epichlorohydrin polycondensates with epichlorohydrin. Specific examples of epoxy resins BIIb that may be used in the invention are NER-7604, NER-7403, NER-1302, and NER 7516 resins manufactured by Nippon-Kayaku Co., Ltd, Tokyo, Japan. The epoxide equivalent weight of the epoxy resins according to Formula BIIb is preferably 200 to 500 g/eq and their softening point is preferably 50 to 90° C. It is to be understood that more than one epoxy resin according to Formula BIIb can be used in the compositions according to the invention.

Compounds that generate a protic acid when irradiated by active rays, such as ultraviolet rays, and the like, are preferred as the cationic photopolymerization initiator (C) used in the present invention. Aromatic iodonium complex salts and aromatic sulfonium complex salts are cited as examples. Di-(t-butylphenyl)iodonium triflate, diphenyliodonium tetrakis(pentafluorophenyl)borate, diphenyliodonium hexafluorophosphate, diphenyliodonium hexafluoroantimonate, di(4-nonylphenyl)iodonium hexafluorophosphate, [4-(octyloxy)phenyl]phenyliodonium hexafluoroantimonate, and the like are cited as specific examples of the aromatic iodonium complex salts that can be used. Moreover, triphenylsulfonium triflate, triphenylsulfonium hexafluorophosphate, triphenylsulfonium hexafluoroantimonate, triphenylsulfonium tetrakis(pentafluorophenyl)borate, 4,4′-bis[diphenylsulfonium]diphenylsulfide bis-hexafluorophosphate, 4,4′-bis[di(β-hydroxyethoxy)phenylsulfonium]diphenylsulfide bis-hexafluoroantimonate, 4,4′-bis[di(β-hydroxyethoxy)(phenylsulfonium)diphenyl sulfide-bishexafluorophosphate 7-[di(p-tolyl)sulfonium]-2-isopropylthioxanthone hexafluorophosphate, 7-[di(p-tolyl)sulfonium-2-isopropylthioxanthone hexafluoroantimonate, 7-[di(p-tolyl)sulfonium]-2-isopropyl tetrakis(pentafluorophenyl)borate, phenylcarbonyl-4′-diphenylsulfonium diphenylsulfide hexafluorophosphate, phenylcarbonyl-4′-diphenylsulfonium diphenylsulfide hexafluoroantimonate, 4-tert-butylphenylcarbonyl-4′-diphenylsulfonium diphenylsulfide hexafluorophosphate, 4-tert-butylphenylcarbonyl-4′-diphenylsulfonium diphenylsulfide hexafluoroantimonate, 4-tert-butylphenylcarbonyl-4′-diphenylsulfonium diphenylsulfide tetrakis(pentafluorophenyl)borate, diphenyl [4-(phenylthio)phenyl]sulfonium hexafluoroantimonate and the like can be cited as specific examples of the aromatic sulfonium complex salt that can be used. Certain ferrocene compounds, such as Irgacure 261 manufacture by Ciba Specialty Chemicals may also be used. The cationic photoinitiators (C) can be used alone or as mixtures of two or more compounds.

A solvent (D) is used in the present invention and any solvent can be used as long as it is an organic solvent capable of dissolving the other components in the composition and does not cause coating defects such a bubbles, dewetted areas, and rough coating surfaces when the compositions are coated and dried on a substrate. Examples of ketone solvents that can be used include acetone, 2-butanone, 2-pentanone, 3-pentanone, methyl isobutyl ketone, methyl t-butyl ketone, cyclopentanone, cyclohexanone, and the like. Examples of ether solvents that can be used include dipropylene glycol dimethyl ether, dipropylene glycol diethyl ether, tetrahydrofuran, 1,3-dioxolane, 1,4-dioxane, dimethoxyethane, diglyme, and triglyme. Examples of ester solvents that can be used include ethyl acetate, butyl acetate, butyl cellosolve acetate, carbitol acetate, propylene glycol monomethyl ether acetate, gamma-butyrolactone, and the like. Examples of aromatic and aliphatic hydrocarbon solvents that can be used in minor amounts in a solvent mixture containing a major amount of one or more solvents selected from the group comprising ketone, ester, or ether solvents include toluene, xylene, tetramethylbenzene, octane, decane, petroleum ether, petroleum naphtha, hydrogenated petroleum naphtha, solvent naphtha, and the like. When used in combination with ketone, ester, or ether solvents, these hydrocarbon solvents can be used alone or as a mixture of two or more hydrocarbon solvents.

Optionally, it may be beneficial in certain embodiments to use an additional epoxy resin (E) in the composition. Depending on its chemical structure, optional epoxy resin (E) may be used to adjust the lithographic contrast of the photoresist or to modify the optical absorbance of the photoresist film. The optional epoxy resin (E) may have an epoxide equivalent weight ranging from 150 to 250 grams resin per equivalent of epoxide. Examples of optional epoxy resins suitable for use include EOCN 4400, an epoxy cresol-novolac resin with an epoxide equivalent weight of about 195 g/eq manufactured by Nippon Kayaku Co., Ltd., Tokyo, Japan; or cycloaliphatic epoxies as disclosed in U.S. Pat. Nos. 4,565,859 and 4,481,017 wherein vinyl substituted alicyclic epoxide monomers are copolymerized with a compound containing a least one active hydrogen atom to produce a vinyl substituted polyether that is subsequently oxidized with a peracid to produce the alicyclic epoxy resin. A preferred commercial example is EHPE 3150 epoxy resin which has an epoxide equivalent weight of 170 to 190 g/eq and is manufactured by Daicel Chemical Industries, Ltd., Osaka, Japan.

Optionally, it may be beneficial in certain embodiments to use a reactive monomer compound (F) in the compositions according to the invention. Inclusion of reactive monomers in the composition helps to increase the flexibility of the uncured and cured film. Glycidyl ethers containing two or more glycidyl ether groups are examples of reactive monomer (F) that can be used. Compounds with two or more functional groups are preferred and diethylene glycol diglycidyl ether, propylene glycol diglycidyl ether, polypropylene glycol diglycidyl ether, hexanediol diglycidyl ether, trimethylolpropane triglycidyl ether, pentaerythritol tetraglycidyl ether, and the like are cited as examples. The glycidyl ethers can be used alone or as mixtures of two or more. Trimethylolpropane triglycidyl ether and polypropylene glycol diglycidyl ether are preferred examples of reactive monomers (F) that can be used in the invention.

Aliphatic and aromatic monofunctional and/or polyfunctional oxetane compounds are another group of optional reactive monomers (F) that can be used in the present invention. Specific examples of the aliphatic or aromatic oxetane reactive monomers that can be used include 3-ethyl-3-hydroxymethyloxetane, 3-ethyl-3-phenoxymethyloxetane, xylylene dioxetane, bis(3-ethyl-3-oxetanylmethyl)ether, and the like. These monofunctional and/or polyfunctional oxetane compounds can be used alone or as mixtures of two or more.

Alicyclic epoxy compounds can also be used as reactive monomer (F) in this invention and 3,4-epoxycyclohexylmethyl methacrylate and 3,4-epoxycyclohexylmethyl-3′,4′-epoxycyclohexane carboxylate may be cited as examples.

Optionally, it may be useful to include photosensitizer compounds (G) in the composition so that more ultraviolet rays are absorbed and the energy that has been absorbed is transferred to the cationic photopolymerization initiator. Consequently, the process time for exposure is decreased. Anthracene and N-alkyl carbazole compounds are examples of photosensitizers that can be used in the invention. Anthracene compounds with alkoxy groups at positions 9 and 10 (9,10-dialkoxyanthracenes) are preferred photosensitizers (G). C₁ to C₄ alkoxy groups such as methoxy, ethoxy, propoxy, and butoxy groups are cited as the preferred alkoxy groups. The 9,10-dialkoxyanthracenes can also have substituent groups. Halogen atoms such as fluorine atoms, chlorine atoms, bromine atoms, and iodine atoms, C₁ to C₄ alkyl groups such as methyl groups, ethyl groups, and propyl groups, sulfonic acid groups, sulfonate ester groups, carboxylic acid alkyl ester groups, and the like are cited as examples of substituent groups. C₁ to C₄ alkyls, such as methyl, ethyl, and propyl, are given as examples of the alkyl moiety in the sulfonic acid alkyl ester groups and carboxylic acid alkyl ester groups. The substitution position of these substituent groups is preferably at position 2 of the anthracene ring system. 9,10-Dimethoxyanthracene, 9,10-diethoxyanthracene, 9,10-dipropoxyanthracene, 9,10-dimethoxy-2-ethylanthracene, 9,10-diethoxy-2-ethylanthracene, 9,10-dipropoxy-2-ethylanthracene, 9,10-dimethoxy-2-chloroanthracene, 9,10-dimethoxyanthracene-2-sulfonic acid, 9,1 0-dimethoxyanthracene-2-sulfonic acid methyl ester, 9,1 0-diethoxyanthracene-2-sulfonic acid methyl ester, 9,1 0-dimethoxyanthracene 2-carboxylic acid, 9,1 0-dimethoxyanthracene-2-carboxylic acid methyl ester, and the like can be cited as specific examples of the 9,10-dialkoxyanthracenes that can be used in the present invention. Examples of N-alkyl carbazole compounds useful in the invention include N-ethyl carbazole, N-ethyl-3-formyl-carbazole, 1,4,5,8,9-pentamethyl-carbazole, N-ethyl-3,6-dibenzoyl-9-ethylcarbazole and 9,9′-diethyl-3,3′-bicarbazole. The sensitizer compounds (G) can be used alone or in mixtures of two or more.

Examples of optional adhesion promoting compounds (H) that can be used in the invention include: 3-glycidoxypropyltrimethoxysilane, 3-glycidoxypropyltriethoxysilane, 3-mercaptopropyltrimethoxysilane, vinyltrimethyoxysilane, [3-(methacryloyloxy)propyl]tri-methoxysilane, and the like.

Optionally, it may be useful to include compounds (J) that absorb actinic rays and have an absorbance coefficient at 365 nm of 15 L/g.cm or higher. Such compounds can be used to provide a relief image cross section that has a reverse tapered shape such that the imaged material at the top of the image is wider than the imaged material at the bottom of the image. Benzophenone compounds such as 2,4-dihydroxybenzophenone and 2,2′,4,4′-tetrahydroxybenzophenone, salicylic acid compounds such as phenyl salicylate and 4-t-butylphenyl salicylate, phenylacrylate compounds such as ethyl-2-cyano-3,3-diphenylacrylate, and 2′-ethylhexyl-2-cyano-3,3-diphenylacrylate, benzotriazole compounds such as 2-(2-hydroxy-5-methylphenyl)-2H-benzotriazole, and 2-(3-t-butyl-2-hydroxy-5-methylphenyl)-5-chloro-2H-benzotriazole, azo dyes such as Sudan Orange G, coumarin compounds such as 4-methyl-7-diethylamino-1-benzopyran-2-one, thioxanthone compounds such as diethylthioxanthone, stilbene compounds, naphthalic acid compounds, and the like are cited as specific examples of the compounds (J) that can be used in the present invention either singly or as mixtures.

Optionally, an organic aluminum compound (K) can be used in the present invention as an ion-gettering agent. There are no special restrictions on the organic aluminum compound as long as it is a compound that has the effect of adsorbing the ionic materials remaining in the cured product. Alkoxyaluminum compounds such as tris-methoxyaluminum, tris-ethoxyaluminum, tris-isopropoxyaluminum, isopropoxydiethoxyaluminum, and tris-butoxyaluminum, phenoxyaluminum compounds such as tris-phenoxyaluminum and tris-para-methylphenoxyaluminum, tris-acetoxyaluminum, tris-aluminum stearate, tris-aluminum butyrate, tris-aluminum propionate, tris-aluminum acetylacetonate, tris-aluminum tolylfluoroacetylacetate, tris-aluminum ethylacetoacetate, aluminum diacetylacetonatodipivaloylmethanate, aluminum diisopropoxy(ethylacetoacetate), and the like are given as specific examples. These components (K) can be used alone or as a combination of two or more components and they are used when it is necessary to alleviate detrimental effects of ions derived from the above-mentioned photoacid generator compounds (C).

The amount of bis-phenol novolac component A that may be used is 5-90 weight % of the total weight of components A, B, and C and where present, optional epoxy resin E, reactive monomer F, and adhesion promoter H, and more preferably 25-90 weight % and most preferably 40-80%.

The amount of epoxy resin component B that may be used is 10-95 weight % of the total weight of components A, B, and C and where present, optional epoxy resin E, reactive monomer F, and adhesion promoter H, and more preferably 15-75 weight % and most preferably 20 to 60 weight %.

The amount of photoacid generator compound C that may be used is 0.1 to 10 weight % of the total weight of epoxy resin components A and B, and where present, optional epoxy resin E, reactive monomer F, and adhesion promoter H. It is more preferred to use 1-8 weight % of C and it is most preferred to use 2-6 weight %.

The amount of solvent component D that may be used is 5 to 99 weight % of the total composition. It is more preferred to use 5 to 90 weight % solvent and most preferred to use 10-85 weight % solvent. The exact amount of solvent that may be used depends on the desired coating thickness. Compositions containing lower amounts of solvent provide higher solids concentrations and are useful for preparing thick film while greater amounts of solvent decrease the solids content and such compositions are useful for preparing thin films.

The solvent component D may comprise a mixture of two of more solvents. Solvent mixtures may be used to modify the viscosity and drying characteristics of the composition in a manner that improves coating quality by reducing the formation of bubbles in the coating. Mixtures of cyclopentanone and methyl ketones are preferred and most preferred are mixtures of cyclopentanone with 2-pentanone wherein the mixture contains 5-25% by weight of 2-pentanone.

When an optional epoxy resin E is used, the amount of resin E that may be used is 5-40 weight % of the total weight of components A, B, and C and where present, optional epoxy resin E, reactive monomer F, and adhesion promoter H and more preferably 10-30 weight % and most preferably 15-30 weight %.

When an optional reactive monomer F is used, the amount of F that may be used is 1-20 weight % of the total weight of components A, B, and C and where present, optional epoxy resin E, reactive monomer F, and adhesion promoter H and more preferably 2-15 weight % and most preferably 4-10 weight %.

When used, optional photosensitizer component G may be present in an amount that is 05 to 4.0 weight % relative to the photoinitiator component C and it is more preferred to use 0.5-3.0 weight % and most preferred to use 1-2.5 weight %.

Optionally, epoxy resins, epoxy acrylate and methacrylate resins, and acrylate and methacrylate homopolymers and copolymers other than components A, B, and E can be used in the present invention. Phenol-novolac epoxy resins, trisphenolmethane epoxy resins, and the like are cited as examples of such alternate epoxy resins, and a methacrylate monomer such as pentaerythritol tetra-methacrylate and dipentaerythritol penta- and hexa-methacrylate, a methacrylate oligomer such as epoxymethacrylate, urethanemethacrylate, polyester polymethacrylte, and the like are cited as examples of methacrylate compounds. The amount used is preferably 0 to 50 weight % of the total weight of components A and B and E.

In addition, optional inorganic fillers such as barium sulfate, barium titanate, silicon oxide, amorphous silica, talc, clay, magnesium carbonate, calcium carbonate, aluminum oxide, aluminum hydroxide, montmorillonite clays, and mica powder and various metal powders such as silver, aluminum, gold, iron, CuBiSr alloys, and the like can be used in the present invention. The content of inorganic filler may be 0.1 to 80 weight % of the composition. Likewise, organic fillers such as polymethylmethacrylate, rubber, fluoropolymers, crosslinked epoxies, polyurethane powders and the like can be similarly incorporated.

When necessary, various materials such as crosslinking agents, thermoplastic resins, coloring agents, thickeners, and agents that promote or improve adhesion can be further used in the present invention. Crosslinking agents can include, for example, methoxylated melamine, butoxylated melamine, and alkoxylated glycouril compounds. Cymel® 303 from Cytec Industries, West Patterson, N.J., is a specific example of a suitable methoxylated melamine compound. Powderlink® 1174 from Cytec Industries, West Patterson, N.J. is a specific example of an alkoxylated glycouril compound. Polyether sulfone, polystyrene, polycarbonate, and the like are cited as examples of thermoplastic resins; phthalocyanine blue, phthalocyanine green, iodine green, crystal violet, titanium oxide, carbon black, naphthalene black, and the like are cited as examples of coloring agents; asbestos, orben, bentonite, and montomorillonite are cited as examples of thickeners and silicone-containing, fluorine-containing, and polymeric defoaming agents are cited as examples of defoaming agents. When these additives and the like are used, their general content in the composition of the present invention is 0.05 to 10 weight % each, but this can be increased or decreased as needed in accordance with the application objective.

The resin composition of the present invention can be prepared by combining components A through D and optional components E though K and when necessary, inorganic filler and other additives, preferably at the above-mentioned ratios, mixing uniformly, dissolving, dispersing, and the like with a roll mill, paddle mixer, or similar devices known in the compounding art. It is particularly preferred that components A through K exclusive of solvent component D are diluted with solvent component D and adjusted to a solution viscosity appropriate to the intended use of the composition.

When using the photoresist compositions of the present invention, the photoresist solution may be applied to a substrate by spin-coating, consisting of dispensing the liquid photoresist onto a substrate, accelerating the substrate to a constant rotational speed, and holding the rotation speed constant to achieve the desired coating thickness. Spin-coating may be performed with variable rotational velocity in order to control the thickness of the final coating. Alternatively, the photoresist composition may be applied to the substrate using other coating methods such as roller coating, doctor bar coating, slot coating, dip coating, gravure coating, spray coating, and the like. After coating, a drying bake is performed to evaporate the solvent. The drying bake conditions are chosen so as to form a tack free film of photoresist and typical conditions are 1 minute at 65° C. followed by 5-30 minutes or longer as may be required, at 95° C. on a hotplate wherein the substrate is in contact or near contact with the surface of the hotplate. Alternatively, the drying bake may be performed in a convection oven. The solid photoresist coating can then be photoimaged using an exposure tool with near-ultraviolet, 300-500 nm, radiation from a medium- or high-pressure mercury lamp, x-ray radiation from a standard or synchrotron source through a photomask containing a pattern of opaque and transparent regions, or by electron beam radiation through direct or patterned exposures. Contact, proximity, or projection printing may be used. Following exposure, a post-exposure-bake is carried out in order to accelerate the acid catalyzed polymerization reaction in the exposed regions of the coating; typical bakes are carried out on a hotplate for I minute at 65° C. and 5 minutes at 95° C. In certain embodiments, the post exposure bake can be carried out by using one bake at 95° C. for 5 to 10 minutes. The coating is then immersed in an organic solvent developer in order to dissolve away the non-polymerized regions, typically for 2-5 minutes depending on the thickness of the coating and the solvent strength of the developer solvent. The developed image is rinsed by application of a rinse solvent to remove residual developer. Removal of the residual developer is necessary because the residual developer contains dissolved photoresist components that will form deposits in the relief image if the residual developer is allowed to dry on the substrate.

Optionally, the developer solvent may be applied by spraying using either an atomizing spray nozzle or fine shower-head type spray nozzle. Yet another method of developing the image comprises applying the developer using what is known in the photoresist art as a puddle process wherein the substrate to be developed is placed on a rotating tool head and then an amount of developer sufficient to form a standing layer or puddle on the entire substrate area is dispensed onto the slowly rotating substrate. Rotation is then stopped and the resulting developer puddle that is formed is allowed to stand on the substrate for a defined period of time. After this time, the substrate is rotationally accelerated to spin off the spent developer and then decelerated until rotation stops. This sequence is repeated, if necessary, until a clear relief image is obtained and it is common to use a process wherein two to four solvent puddles are formed.

Suitable developer solvents include, but are not limited to, propylene glycol methyl ether acetate, gamma-butyrolactone, acetone, cyclopentanone, diacetone alcohol, tetrahydrofurfuryl alcohol, N-methyl pyrrolidone, anisole, and ethyl lactate. The developer solvents can be used singly or as mixtures. Propylene glycol methyl ether acetate is particularly preferred because of its good solvency for the unexposed photoresist components and relatively low cost.

Suitable rinse solvents include any of the developer solvents mentioned above as well as methanol, ethanol, isopropanol, and n-butyl acetate. It is preferred that the rinse solvents dry quikly and in this regard acetone, methanol, ethanol, and isopropanol are particularly preferred.

Optionally, a post-bake may be performed on the resulting image to more fully harden the material by driving the polymerization reaction to a higher degree of conversion. This process is readily accomplished using heating equipment such as hot plates, convection ovens, and the like.

Substrate materials that can be used include, but are not limited to, silicon, silicon dioxide, silicon nitride, alumina, glass, glass-ceramics, gallium arsenide, indium phosphide, copper, aluminum, nickel, iron, steel, copper-silicon alloys, indium-tin oxide coated glass, organic films such as polyimide and polyester, any substrate bearing patterned areas of metal, semiconductor, and insulating materials, and the like. Optionally, a bake step may be performed on the substrate to remove absorbed moisture prior to applying the photoresist coating.

The photoresist compositions of the present invention can be used to manufacture dry film photoresists. To prepare a dry film photoresist, a photoresist composition according to the present invention is applied to a base film material using coating methods such as roller coating, doctor bar coating, slot coating, dip coating, spin coating, gravure coating, and the like. The coated base film is then dried in a drying oven set at 60 to 160° C. for a time sufficient to remove the desired amount of solvent. A cover film is then applied to the photoresist side of the coated film to protect the film from damage and to prevent sheets of coated material from sticking together. The thickness of the photoresist on the base film may be adjusted from about 1 to about 100 μm by suitable selection of solvents, photoresist solids content, and coating parameters. Organic polymer film materials such as polyethylene terephthalate, polypropylene, and polyimide can be used as the base film. Organic polymers such as polyethylene, polypropylene, and polyethylene terephthalate can be used as the cover sheet material.

The dry film photoresist may be used by first peeling or otherwise removing the protective cover sheet from the photoresist layer, then placing the dry film on a substrate with the photoresist side in contact with the substrate, laminating the photoresist to the substrate by application of heat and pressure using a conventional lamination device and then peeling or otherwise removing the base film from the photoresist layer. These operations result in forming a photoresist layer on the substrate which may be subsequently processed by image-wise exposing, post-exposure baking, developing an image and by optionally, curing by heating, using the methods described herein or conventionally practiced.

The dry film photoresist may also be used by peeling or otherwise removing the protective cover sheet from the photoresist layer, then placing the dry film layer on a substrate with the photoresist side in contact with the substrate, laminating the photoresist to the substrate by application of heat and pressure using a conventional lamination device; then image-wise exposing the photoresist layer by irradiation through the base film; peeling or otherwise removing the base film from the image-wise exposed photoresist layer; subjecting the image-wise exposed photoresist layer to a post-exposure bake; developing the image in the photoresist; and optionally heating the developed photoresist to cure, such steps using methods described herein or conventionally practiced.

The dry film photoresist may also be used by peeling or otherwise removing the protective cover sheet from the photoresist layer; then placing the dry film layer on a substrate with the photoresist side in contact with the substrate; laminating the photoresist to the substrate by application of heat and pressure using a conventional lamination device; then image-wise exposing the photoresist layer by irradiation through the base film; subjecting the laminate of base film, photoresist layer and substrate to a post exposure bake; peeling or otherwise removing the base film from the image-wise exposed and post exposure baked photoresist layer, subjecting that photoresist layer to developing to create an image in the photoresist, and optionally heating the developed photoresist to cure, such steps using methods described herein or conventionally practiced.

The cured product of the resin compositions according to the invention may be used as permanent layers in articles of manufacture including MEMS and micromachine components. For example, it can be used for micromachine components as disclosed in Japanese Kokai Patent No. 2000-343,463; office components for ink jet heads as disclosed in Japanese Kokai Patent No. 2001-10,068; magnetic actuator (MEMS) components as disclosed in Japanese Kokai Patent No. 2001-71,299; microchips (μ-TAS) for capillary gel electrophoresis as disclosed in Japanese Kokai Patent No. 2001-157,855; as well as microfluidic channels and cell growth platforms for biological MEMs devices, microreactor components, dielectric layers, insulation layers, and resin substrates.

The coated, imaged, developed and optionally cured products of the compositions according to the invention may be used to form a reactive ion etch mask used in the fabrication of high density, area array printing plates for printing biological inks as disclosed in U.S. patent application No. 2003/0059344 or in the fabrication of cell transfection plates and transfection apparatus as disclosed in U.S. Pat. Nos. 6,652,878 and 6,670,129. As an additional example from field of biological applications, the compositions according to the invention may be used to fabricate a plurality of microfluidic channels in devices for parallel, in-vitro screening of biomolecular activity as taught in U.S. Pat. Nos. 6,576,478 and 6,682,942.

In the field of MEMS, the coated, imaged, and optionally cured products of the compositions according to the invention may be used in the fabrication of: micro-power switching devices as taught in U.S. Pat. No. 6,506,989; insulating layers in microrelay devices as taught in U.S. Pat. No. 6,624,730; drug delivery devices and sensors as taught in U.S. Pat. No. 6,663,615; multilayer relief structures as described in U.S. Pat. No. 6,582,890; and electromagnetic actuators as described in U.S. Pat. No. 6,674,350. Further and in the area of sensors, the compositions may be used, for example, in the fabrication of ultraminature fiber optic pressure transducers as taught in U.S. Pat. No. 6,506,313 and the fabrication of cantilever tips for application in atomic force microscopy (AFM) as taught in U.S. Pat. No. 6,219,140.

The coated, imaged, and optionally cured product of the compositions according to the invention may be used in electronic packaging applications related to forming protective coatings on semiconductor wafers and singulated devices as taught in U.S. Pat. No. 6,544,902.

Several U.S. patents teach the use of dry film resists to making electrical printed circuit boards, offset printing plates and other copper-clad laminates. These include: U.S. Pat. Nos. 3,469,982; 4,193,799; 4,576,902; 4,624,912 and 5,043,221. U.S. Pat. No. 3,708,296 teaches the use of dry film photoresist in making acid and alkali resist images for chemical milling, screenless lithography, printing plates, stencil making, microimages for printed circuitry, thermoset vesicular images, microimages for information storage, decoration of paper, glass and metal packages and light cured coatings. The laminated, imaged and cured dry-film photoresists of the present invention may be used in place of the dry film resists disclosed in these references.

There have been numerous disclosures in the patent literature that describe the utility of epoxy resin-containing photoresists in the fabrication of the print head component of ink jet printer cartridges wherein the coated, imaged, and optionally cured products of the compositions according to this invention may be used in place of the resists disclosed in the patents. A by no means inclusive, but illustrative group of examples showing applications in the area of ink jet print heads include the teachings of U.S. Pat. Nos. 5,859,655, 6,193,359, 5,969,736, 6,062,681, 6,419,346, 6,447,102, 6,305,790, and 6,375,313

The compositions of the present invention may also be used as substrate bonding adhesives wherein a substrate coated with the composition is brought into contact with a second substrate such that, under suitable conditions of heat and pressure, an adhesive bond is formed between the two substrates. Depending upon the heat and pressure conditions used, this adhesive bond may be either temporary or permanent. In this use, a temporary adhesive bond is an adhesive bond that can be broken by treatment of the bonded substrates with a solvent while a permanent bond is an adhesive bond that is not weakened by solvent treatment.

Permanent resist patterns may be formed in coated layers of the compositions by using imprinting methods. Imprinting is the process of transferring a pattern from a template to a substrate by physical contact. The compositions of the invention may be used in imprinting by coating the composition on a surface and then baking the wet coating to dry the film and provide an imprinting substrate. Next, a template bearing elevated features that may have either micron or submicron size features is brought into physical contact with the imprinting substrate. Pressure is then applied to the template, or to the imprinting substrate, or to both the template and imprinting substrate in a manner that causes the elevated features of the template to penetrate into the bulk of the permanent resist coating composition. The efficacy of the imprinting process may be aided by applying heat to the imprinting substrate to soften the permanent resist coating. The template is then separated from the imprinting substrate to provide a patterned substrate wherein the elevated features of template become recessed images in the permanent photoresist coating. This process is described as microimprinting when the feature size is in the micron range and nanoimprinting when the feature size is less than a micron. The transferred pattern may be fixed into the substrate film by exposing the pattern to UV radiation to initiate cationic polymerization of the photoresist composition and then performing a subsequent bake step to complete polymerization and cross linking of the film. Alternatively and without the use of ultraviolet or other active rays, either before or after separation of the template from the imprinted substrate, the patterned substrate may be heated to a temperature sufficient to activate PAG decomposition and subsequent cationic polymerization and thereby provide the permanent photoresist layer. It is possible to combine the processes of imagewise, ultraviolet lithography as described above with imagewise imprinting lithography to provide a patterned permanent photoresist coating on a substrate in which some portion of the relief pattern is formed by the photolithographic process and some portion by the imprinting process.

The photoresist compositions according to the invention have excellent imaging characteristics and the cured products have excellent chemical resistance to solvents, alkalis, and acids and show good thermal stability and electrical properties.

The present invention is further described in detail by means of the following Examples and Comparisons. All parts and percentages are by weight and all temperatures are degrees Celsius unless explicitly stated otherwise.

### EXAMPLES AND EXPERIMENTS

General Experimental Procedures for Testing Photoresist Samples

### Method for Formulating Photoresist Composition Examples 1 through 19, 30 and 31 and

### Comparative Examples 1 through 4

All photoresist compositions were prepared by individually weighing the components of the compositions into 4 ounce, wide-mouth amber glass bottles. The calculated amount of solvent was then added to provide compositions wherein the total solids content was 70 or 75 percent of the total composition. Total solids content is defined herein as the additive weight of all components of the composition except solvent less the carrier solvent of the PAG where applicable. The bottle was tightly capped and then rolled on a roller mill under an infrared heat lamp at 40-60° C. for 4-8 hr until all components were completely dissolved. The samples were allowed to cool to room temperature and were evaluated without further manipulation.

The chemical or trade names, sources, and identifying codes of the substances used to prepare the photoresist compositions are listed in Table 1. The formularies of each Example and Comparative Example composition are described in Table 2.

In regard to the construction and understanding of Table 2, it is to be understood that the numerical entries shown in italic print in the third line of a table cell states the weight percent of a given component in the total composition. These percentages are approximate and may not add to exactly 100 percent. The numerical entries shown in normal type face in the second line of a table cell describe the content of a component in the composition relative to other components of the composition. In particular, the content of film forming resins (A, B, and optionally E), reactive monomers (F), and adhesion additives (H) are expressed as a percentage by weight of the total content of film forming resin (A, B, and optionally E), reactive monomer (F), and adhesion additive (H). The PAG (C) content is expressed as a percentage by weight of the total content of film forming resin (A, B, and optionally E), reactive monomer (F), and adhesion additives (H). The content of optional photosensitizer (G) is expressed as a percentage by weight of the content of PAG (C). The content of optional light absorbing dye (H) is expressed as a percentage by weight of the content of PAG (C).

TABLE 1
List of material identities, material sources, material functions, compositional use, and text reference codes.

| | | | Use in | Reference |
|---|---|---|---|---|
| Material | Supplier | Function | Composition | Code |
| SU-8 Epoxy Resin | Resolution Performance Chemicals | Film Forming Resin | A | SU8 |
| Epicoat 157 Epoxy Resin | Japan Epoxy Resin Company, Ltd. | Film Forming Resin | A | E157 |
| NC-3000 Epoxy Resin | Nippon Kayaku | Film Forming Resin | BIIa | N3000 |
| NC-3000H Epoxy Resin | Nippon Kayaku | Film Forming Resin | BIIa | N3000H |
| NER-7403 Epoxy Resin | Nippon Kayaku | Film Forming Resin | BIIb | E7403 |
| NER-7604 Epoxy Resin | Nippon Kayaku | Film Forming Resin | BIIb | N7604 |
| NER-7516 Epoxy Resin | Nippon Kayaku | Film Forming Resin | BIIb | N7516 |
| EOCN-4400 Epoxy Resin | Nippon Kayaku | Film Forming Resin | E | E4400 |
| EHPE-3150 Epoxy Resin | Daicel | Film Forming Resin | E | E3150 |
| Epotote YD-017 Epoxy Resin | Toto Kasei, Ltd. | Film Forming Resin | Comparative | Y017 |
| | | | Resin | |
| Cyracure 6974 (Mixed aryl sulfonium SbF6 salts, 50% | Dow Chemical Company | PAG | C | C6974 |
| solution in propylene carbonate solvent) | | | | |
| Thiophenyldiphenylsulfonium hexafluoroantimonate | San Apro Chemical Company | PAG | C | TPPS |
| CPI-101A (thiophenyldiphenylsulfonium | San Apro Chemical Company | PAG | C | C101A |
| hexafluoroantimoate 50% in propylene carbonate solvent) | | | | |
| Octyloxyphenylphenyl iodonium hexafluoroantimonate | Hampford Research | PAG | C | OPPI |
| SP-172 (50% solution in propylene carbonate solvent) | Asahi Denka | PAG | C | S172 |
| Cyclopentanone | Rhodia | Solvent | D | CP |
| 2-Heptanone | Eastman Kodak | Solvent | D | 2HP |
| 2-Pentanone | Eastman Kodak | Solvent | D | 2PT |
| Trimethyolpropane trigylcidylether | Resolution Performance Products | Reactive Monomer | F | TMPTGE |
| Glycerol triglycidylether | Aldrich Chemical Company | Reactive Monomer | F | GTE |
| ED 506 (polypropylene glycol diglycidyl ether) | Asahi-Denka | Reactive Monomer | F | E506 |
| Xylylene dioxetane | Toyo-Gosei | Reactive Monomer | F | XYDO |
| 2-Ethyl-9,10-dimethoxyanthracene | Hampford Research | Photosensitizer | G | EDMA |
| 9,10-Dimethoxyanthracene | Aldrich Chemical Company | Photosensitizer | G | DMA |
| 3-glycidoxypropyltrimethoxysilane | Dow Corning, Chisso | Adhesion Additive | H | GPS |
| Kayalight B | Nippon Kayaku | Light Absorbing Dye | J | KB |
| 2,4-Diethylthioxanthone | Nippon-Kayaku | Light Absorbing Dye | J | DETXA |
| Aluminum triacetylacetonate | | Ion Getting Agent | K | ALCMP |

TABLE 2
Detailed formularies of the Example and Comparative Example compositions according to the invention.

| | Film | Film | Film | | | | | | | |
|---|---|---|---|---|---|---|---|---|---|---|
| | Forming | Forming | Forming | Reactive | | | | Solvent | Solvent | Adhesion |
| Experiment | Resin 1 | Resin 2 | Resin 3 | Monomer | PAG | Sensitizer | Dye | 1 | 2 | Additive |
| Example 1 | SU8 | N3000H | None | TMPTGE | C6974 | None | None | CP | None | None |
| | 75 | 20 | | 5% | 5% | | | | | |
| | 50.00 | 13.34 | | 3.33 | 6.66 | | | 26.67 | | |
| Example 2 | SU8 | N3000H | None | GTE | C6974 | None | None | CP | None | None |
| | 75 | 20 | | 5 | 5 | | | | | |
| | 50.00 | 13.33 | | 3.33 | 6.66 | | | 26.68 | | |
| Example 3 | SU8 | N3000H | None | None | C6974 | None | None | CP | None | None |
| | 80 | 20 | | | 5 | | | | | |
| | 53.33 | 13.33 | | | 6.66 | | | 26.68 | | |
| Example 4 | SU8 | N3000H | None | TMPTGE | C6974 | None | None | CP | None | None |
| | 72 | 20 | | 8 | 5 | | | | | |
| | 48.00 | 13.33 | | 5.33 | 6.66 | | | 26.68 | | |
| Example 5 | SU8 | N3000H | None | TMPTGE | C6974 | None | None | CP | None | None |
| | 42 | 50 | | 8 | 5 | | | | | |
| | 28.00 | 33.33 | | 5.33 | 6.66 | | | 26.68 | | |
| Example 6 | SU8 | N3000H | None | None | C6974 | None | None | CP | None | None |
| | 50 | 50 | | | 5 | | | | | |
| | 33.33 | 33.33 | | | 6.66 | | | 26.68 | | |
| Example 7 | SU8 | N3000H | E3150 | TMPTGE | C6974 | None | None | CP | None | None |
| | 36 | 20 | 36 | 8 | 5 | | | | | |
| | 24.00 | 13.33 | 24.00 | 5.33 | 6.66 | | | 26.68 | | |
| Example 8 | SU8 | N7516 | None | TMPTGE | C6974 | None | None | CP | None | None |
| | 46% | 46% | | 8% | 5% | | | | | |
| | 30.67 | 30.67 | | 5.33 | 6.66 | | | 26.67 | | |
| Example 9 | SU8 | N7516 | None | TMPTGE | C6974 | None | None | CP | None | None |
| | 72 | 20 | | 8 | 5 | | | | | |
| | 48.00 | 13.33 | | 5.33 | 6.66 | | | 26.68 | | |
| Example 10 | SU8 | N3000H | None | TMPTGE | TPPS | None | None | CP | 2PT | None |
| | 73 | 20 | | 7 | 5 | | | | | |
| | 53.16 | 14.56 | | 5.10 | 2.18 | | | 22.50 | 2.50 | |
| Example 11 | SU8 | N3000H | None | TMPTGE | TPPS | None | None | CP | 2PT | GPS |
| | 72.4 | 19.7 | | 6.4 | 5 | | | | | 1.5 |
| | 52.72 | 14.35 | | 4.66 | 2.18 | | | 22.50 | 2.50 | 1.09 |
| Example 12 | SU8 | N3000H | E3150 | TMPTGE | TPPS | None | None | CP | 2PT | GPS |
| | 54.7 | 19.7 | 17.7 | 6.4 | 5 | | | | | 1.5 |
| | 39.83 | 14.35 | 12.89 | 4.66 | 2.18 | | | 22.50 | 2.50 | 1.09 |
| Example 13 | SU-8 | N3000H | None | TMPTGE | OPPI | EDMA | None | CP | 2PT | None |
| | 68.5 | 25 | | 6.5 | 4 | 2.0 | | | | |
| | 49.40 | 18.03 | | 4.69 | 2.88 | 0.058 | 22.50 | 2.50 | | |
| Example 14 | SU8 | N3000H | None | TMPTGE | OPPI | EDMA | None | CP | 2HP | GPS |
| | 73.5 | 20 | | 5.0 | 4 | 1.25 | | | | 1.5 |
| | 53.00 | 14.42 | | 3.61 | 2.88 | 0.036 | | 22.50 | 2.50 | 1.08 |
| Example 15 | SU8 | N3000H | None | TMPTGE | OPPI | EDMA | None | CP | 2PT | GPS |
| | 68.5 | 25 | | 5.0 | 4 | 1.5 | | | | 1.5 |
| | 51.02 | 18.62 | | 3.72 | 2.98 | 0.045 | | 20.25 | 2.55 | 1.12 |
| Example 16 | SU8 | N3000H | NER7000 | TMPTGE | C6974 | None | None | CP | None | None |
| | 72.0% | 10% | 10% | 8.0% | 5% | | | | | |
| | 48.00 | 6.67 | 6.67 | 5.33 | 6.66 | | | 26.68 | | |
| Example 17 | SU8 | N7604 | None | E506 | C6974 | None | None | CP | None | GPS |
| | 50 | 44 | | 4.0 | 5 | | | | | 2.0 |
| | 34.62 | 30.46 | | 2.77 | 5.54 | | | 25.23 | | 1.38 |
| Example 18 | SU8 | E7604 | E3150 | E506 | C6974 | None | None | CP | None | GPS |
| | 50.0 | 22.0 | 22.0 | 4.0 | 5 | | | | | 2.0 |
| | 34.62 | 15.23 | 15.23 | 2.77 | 5.54 | | | 25.23 | | 1.38 |
| Example 19 | SU8 | N3000H | None | TMPTGE | OPPI | EDMA | None | CP | 2PT | GPS |
| | 68.5 | 25 | | 5.0 | 4 | 1.5 | | | | 1.5 |
| | 36.21 | 13.21 | | 2.65 | 2.11 | 0.032 | | 40.50 | 4.50 | 1.00 |
| Example 20 | E157 | N3000 | None | None | C6974 | None | None | CP | None | None |
| | 10 | 90 | | | 4 | | | | | |
| | 5.56 | 50.00 | | | 4.44 | | | 40.00 | | |
| Example 21 | E157 | N3000 | None | None | C6974 | None | None | CP | None | None |
| | 50 | 50 | | | 4 | | | | | |
| | 27.78 | 27.78 | | | 4.44 | | | 40.00 | | |
| Example 22 | E157 | N3000 | None | None | C6974 | None | None | CP | None | None |
| | 90 | 10 | | | 4 | | | | | |
| | 50.00 | 5.56 | | | 4.44 | | | 40.00 | | |
| Example 23 | E157 | N3000 | None | None | C6974 | None | None | CP | None | None |
| | 44.4 | 55.6 | | | 4.4 | | | | | |
| | 23.53 | 29.41 | | | 4.71 | | | 42.35 | | |
| Example 24 | E157 | N7403 | None | None | C6974 | None | DETXA | CP | None | None |
| | 60 | 40 | | | 4 | | 2.5 | | | |
| | 33.31 | 22.21 | | | 4.44 | | 0.06 | 39.98 | | |
| Example 25 | E157 | N3000 | N7403 | None | C6974 | DMA | None | CP | None | None |
| | 50 | 30 | 20 | | 4 | 2.5 | | | | |
| | 27.76 | 16.66 | 11.10 | | 4.44 | 0.06 | | 39.98 | | |
| Example 26 | E157 | N7403 | None | TMPTGE | C6974 | None | None | CP | None | None |
| | 60 | 25 | | 15 | 4 | | | | | |
| | 33.34 | 13.89 | | 8.33 | 4.44 | | | 40.00 | | |
| Example 27 | E157 | N7403 | None | XYDO | C6974 | None | None | CP | None | None |
| | 60 | 25 | | 15 | 4 | | | | | |
| | 33.34 | 13.89 | | 8.33 | 4.44 | | | 40.00 | | |
| Example 28 | E157 | N3000 | E4400 | None | SP172 | None | None | CP | None | None |
| | 50 | 30 | 20 | | 4 | | | | | |
| | 27.78 | 16.67 | 11.11 | | 4.44 | | | 40.00 | | |
| Example 29 | E157 | N3000 | None | TMPTGE | SP172 | None | None | CP | None | None |
| | 62.5 | 25.0 | | 12.5 | 5 | | | | | |
| | 31.25 | 12.50 | | 6.25 | 5.00 | | | 45.00 | | |
| Example 30 | SU8 | N3000H | N7604 | TMPTGE | OPPI | EDMA | None | CP | 2PT | GPS |
| | 53.5 | 25 | 15 | 5.0 | 4 | 1.0 | | | | 1.5 |
| | 39.85 | 18.62 | 11.17 | 3.73 | 2.98 | 0.0298 | | 20.25 | 2.25 | 1.12 |
| Example 31 | SU8 | N3000H | N7604 | TMPTGE | C101A | None | None | CP | 2PT | GPS |
| | 53.5 | 25 | 15 | 5.0 | 8 | | | | | 1.5 |
| | 38.39 | 17.94 | 10.76 | 3.59 | 5.74 | | | 20.25 | 2.25 | 1.08 |
| Comparative | SU8 | None | None | None | C6974 | None | None | CP | None | None |
| Example 1 | 100 | | | | 5 | | | | | |
| | 66.62 | | | | 6.66 | | | 26.72 | | |
| Comparative | E3150 | N7516 | None | TMPTGE | C6974 | None | None | CP | None | None |
| Example 2 | 72 | 20 | | 8 | 5 | | | | | |
| | 48.00 | 13.33 | | 5.33 | 6.66 | | | 26.68 | | |
| Comparative | E3150 | None | None | None | C6974 | None | None | CP | None | None |
| Example 3 | 100 | | | | 5% | | | | | |
| | 67.31 | | | | 6.73 | | | 25.96 | | |
| Comparative | N3000H | N7516 | None | TMPTGE | C6974 | None | None | CP | None | None |
| Example 4 | 46.0 | 46.0 | | 8.0 | 5 | | | | | |
| | 30.67 | 30.67 | | 5.33 | 6.66 | | | 26.68 | | |
| Comparative | Y017 | N7403 | None | None | C6974 | None | None | CP | None | None |
| Example 5 | 83.3 | 16.7 | | | 3.3 | | | | | |
| | 50.00 | 10.00 | | | 4.00 | | | 36.00 | | |
| Comparative | E157 | Y017 | None | None | C6974 | None | None | CP | None | None |
| Example 6 | 20 | 80 | | | 4 | | | | | |
| | 11.11 | 44.44 | | | 4.44 | | | 40.00 | | |
| Comparative | N7516 | None | None | TMPTGE | C6974 | None | None | CP | None | None |
| Example 7 | 92 | | | 8 | 5 | | | | | |
| | 61.33 | | | 5.33 | 6.66 | | | 26.68 | | |

The following description of experiments refers to Examples 1 through 18 and to Comparative Examples I through 4 and Comparative Example 7.

Method for Preparation of Samples for Physical Testing:

The physical properties of the photoresist samples were evaluated by coating the resists onto 3 mil (75 μm) thick Kapton® polyimide films and evaluating the properties of the resulting film after each process step had been completed.

Samples were prepared by cutting Kapton into 3×3 inch (76×76 mm) squares from a rolled sheet of Kapton. The resulting Kapton squares had a slight curl in the direction of the roll and the composition was coated onto the concave side of the curl. The squares were temporarily attached to a 100 mm diameter silicon wafer by placing approximately 0.5 mL of water or gamma-butyrolactone onto the wafer and then placing the Kapton film on top of the liquid. The liquid spread to cover the entire bottom surface of the Kapton film and the wafer was spun at 500 rpm to remove the excess liquid. The Kapton was then cleaned while spinning at 500 rpm by washing with a stream of acetone followed by a stream of isopropyl alcohol and then spun dry at 1000-3000 rpm. Approximately 5 mL of the composition was poured onto the Kapton film and then spun at 2000-3000 rpm for 30 seconds to give the desired nominal film thickness. The 70% solid mixtures gave nominal 35 μm thick films at 3000 rpm and 75% solid mixtures gave nominal 50 μm thick films at 3000 rpm after softbake. The coated Kapton squares were separated from the wafer and immediately soft baked and dried on a laboratory hot plate for 3 minutes at 65° C. and then quickly transferred to a second hot plate and baked an additional 7 minutes at 95° C. for 35 μm thick films and 10 minutes at 95° C. for 50 μm thick films. The films were held relatively flat to the hotplate surface by using a 2.75×2.75 inch, four-pronged, wire cage with a mass of 8 grams to hold the corners of the film in contact with the hotplate during the bake. The films were transferred to a thermally non-conductive surface and allowed to stand for at least 1 hour before further processing. A 1 inch wide section of the film was cut off of the square using a paper cutter and this section was used to evaluate the properties after the softbake step.

The remaining 2×3 inch piece was then flood exposed on an AB-M, Inc. contact exposure tool using a 320 nm glass cut-off filter to hold the film flat. The photoresist coatings were exposed using a dose of 500-800 mJ/cm², or about double the expected dose on silicon, except for Examples 14, 15, 16, 20, 31 and 32 containing OPPI PAG which were exposed at 100-225 mJ/cm². The exposed films were baked for 3 minutes at 65° C. followed immediately by baking for 7 minutes at 95° C. (hereinafter a baking step done immediately following an exposure step is termed a post-exposure bake and is abbreviated as PEB). The coatings were then cooled on a non-conductive surface for at least 1 hour. During the 95° C. bake a glass plate measuring 5×5× 1/16 inch with a mass of 80 grams was placed on top of the coated Kapton film to keep it flat on the hot plate. All samples rapidly curled to different degrees upon cooling after removal from the hot plate. A 1 inch wide section of this film was cut off and was used to evaluate the properties after PEB.

The remaining 2×2 inch square coated film was then hardbaked at 150° C. for 30 minutes while covered by the glass plate and again cooled on a non-conductive surface for at least 1 hour. After hard bake the Kapton pieces showed significantly more curl than after PEB. These materials would curl rather tightly immediately upon cooling, but then would stress relax over time and uncurl to some degree. The 2×2 inch piece was then cut in half perpendicular to the direction of curl so that each piece was highly curled. One of the 1×2 inch pieces was used to evaluate the physical properties after the 150° C. hard bake. The second 1×2 inch piece was then baked on a hot plate at 250° C. for 5 min under the glass plate and cooled on a non-conductive surface for at least 1 hour. After the 250° C. hard bake, the coated films showed significantly more curl than after the 150° C. hard bake. This final piece was also used to evaluate the physical properties after the combined 150 and 250° C. hard bake steps.

Testing of Physical Properties:

The brittleness of the softbaked film was evaluated by examining the sheared edge of the 1 inch cut piece. Films were considered to pass this test if they showed a clean cut with no shattering or delamination along the edge. Films that failed the test showed cracking, shattering and/or delamination along this edge. The tackiness of the softbaked films was determined by pressing a finger onto the film for 2 seconds and observing the impression left on the coating. Tackiness of the soft baked films could also be noted where the two sides stuck to each other during a forward crease test, wherein the coating on the film is folded and creased onto itself. Flexibility and toughness were evaluated via a reverse crease test where the Kapton backing of the film is folded and pressed against itself. Only the most flexible films could pass this test after PEB or hard bake. Most films would crack and delaminate to varying degrees. Adhesion to the Kapton could also be estimated by the amount of delamination that occurred after crack failure in the reverse crease or reverse bend tests. Better samples would crack but not delaminate from the Kapton and poor samples would crack and extensively delaminate from the Kapton. Films which only cracked but did not delaminate were considered to have passed the reverse crease test whereas films that delaminated as well as cracked were considered to have failed, Further, flexibility was determined by bending the Kapton side of the film around cylinders of different diameters, ranging from 12 mm down to 4 mm in 2 mm increments. The more brittle films would crack and perhaps delaminate at larger cylinder diameters and the most flexible could be bent around a 4 mm cylinder without cracking or delaminating.

A summary of the sticking, bending, and flexure tests performed on Examples and Comparative Examples of the invention is shown in Table 3. The symbols used in Table 3 take the following meanings in each test:
Sticking Test:
   P=Sample coating passed the test and showed no finger impression in the coating and the coating did not stick to itself during the forward crease test.
   F=Sample coating failed the test and showed a finger impression in the coating and coating stuck to itself during the forward crease test.
Delamination Test:
   P=Sample coating passed the test by showing no delamination from the Kapton substrate during either the reverse crease or the reverse bend test.
   F=Sample coating failed the test by showing delamination from the Kapton substrate during either the reverse crease or the reverse bend test.
Bend Test:
   P-#=Sample coating passed the test by showing no cracking or delamination when the Kapton side of the coated substrate was bent around a cylinder 4 to 12 mm in diameter and where # is the cylinder diameter in millimeters where failure by cracking or delamination was observed.
   F-#=Sample coating failed the test by showing cracking or delamination when the coated Kapton substrate was bent around a cylinder of 4 to 12 mm in diameter and where # is the cylinder diameter in millimeters where failure by cracking or delamination was observed. Thus, F-4 means failure when the coated Kapton substrate was bent around a cylinder 4 mm in diameter.

The data indicates that stickiness of the films after softbake was related to the amount of optional components (F) and (H) in the resin formulation. If the combined amount of these two optional additives was greater that 7% of the resin components the film would be excessively stick and if the amount was less than 6% the amount of sticking was below acceptable levels. The tendency to crack and delaminate after soft bake was reduced by the addition of component resins (BIIa) and/or (BIIb) as well as the optional monomer (F). Films not containing resin Component (B) would readily crack, shatter and delaminate from the Kapton film. Only after hardbaking would films crack rather than shatter.

After exposure and PEB all films, including films containing Component (B), would crack and delaminate when the Kapton support film was-creased against itself. As the films were subsequently hardbaked they would continue to crack, but the adhesion of films containing Component (B) improved substantially and would no longer delaminate from the Kapton substrate. The inclusion of optional additives (F) and (H) would further improve the performance of the films. Examination of the flexibility of the Example films, as demonstrated by the ability to bend them around cylinders of different diameters, after exposure and PEB as well as after the two different hardbakes, shows that the flexibility is substantially improved as the amount of Component B in the formulation is increased and as the baking (crosslinking) of the film is extended. Films not containing Component B would crack at much larger diameters than films containing Component B. Typically films containing larger amounts of Component B would pass the 4 mm bend test. Again inclusion of optional additives (F) and (H) additionally improved the performance of the films. Differences between some test results often results from subtleties in the amount of exposure, atmospheric conditions, delay times and other uncontrolled conditions.

TABLE 3
Summary of results for sticking, delamination, and bending tests.

| | Softbaked | | | PEB | | Hard Bake 150° C. | | Hard Bake 250° C. | |
|---|---|---|---|---|---|---|---|---|---|
| Experiment | Sticking | Delamination | Bend | Delamination | Bend | Delamination | Bend | Delamination | Bend |
| 1 | P | P | P-8 | F | F-8 | F | P-8 | F | F-6 |
| 2 | P | P | P-8 | F | F-8 | F | P-8 | F | F-8 |
| 3 | P | F | F-8 | F | F-6 | F | F-8 | F | F-8 |
| 4 | F | P | P | F | P | P | F-4 | P | P |
| 5 | F | P | P | F | F-4 | F | P | P | P |
| 6 | P | F | P | F | F-8 | F | F-8 | F | F-8 |
| 7 | F | P | P | F | P | F | F-4 | P | F-4 |
| 8 | F | P | P | F | P | P | P | P | P |
| 9 | F | P | P | F | F-6 | F | F-4 | P | P |
| 10 | P | P | P | F | P | P | F-4 | P | F-6 |
| 11 | P | P | P | F | P | P | F-4 | P | F-6 |
| 12 | P | P | P | F | P | P | F-6 | P | P |
| 15 | P | P | P | F | P | F | F-8 | P | F-4 |
| 17 | P | P | P | F | P | P | P | P | P |
| 18 | P | P | P | F | P | P | F-4 | P | F-4 |
| C1 | P | F | F-8 | F | F-8 | F | F-8 | F | F-8 |
| C2 | F | P | P | F | F-12 | F | F-8 | P | P |
| C3 | P | F | F-12 | F | F-6 | F | F-8 | F | F-6 |
| C4 | F | P | P | F | F-8 | F | F-4 | P | P |
| C7 | F | P | P | F | P | F | F-4 | P | F-4 |

Preparation of Samples for Lithographic Testing.

Each of the samples was spin coated onto new or previously-cleaned 100 mm diameter silicon wafers on a Brewer Science CEE 100CB spin coater at a spin speed determined to give a film thicknesses of 35 or 50 μm, baked on the attached hotplates for I minute at 65° C. then 5 minutes at 95° C., and then allowed to cool slowly. Next, the wafers were image-wise exposed at 300-800 mJ/cm², except for Examples 13, 14, 15, and 19 which were exposed at 50-300 mJ/cm², using a multistep transmission test mask designed by MicroChem Corp. on the AB-M, Inc. light source with an output power at 365 nm of 14.70 mW/cm2. The wafers were then post exposure baked on hotplates for 1 minute at 65° C. and then for 4 minutes at 95° C., and allowed to cool slowly. After the wafers were cooled, the images were developed in propylene glycol monomethyl ether acetate using a puddle develop process, rinsed with isopropanol and allowed to spin dry. The relief images were inspected in both top-down and in cross-section modes to assess the images for cracking at the corners of square vias, for delamination of the film at the corners of large pads, and for minimum resolution of line and space patterns.

A summary of lithographic results for line and space pair resolution is shown in Table 4 The data shows that the lithographic performance in terms of resolution was best for samples containing large amounts of Component (A), and was only slightly reduced when more than 50% of this component was incorporated into the formulation. When Examples containing small amounts of Component (A) were evaluated poor resolution was obtained and when no Component (A) was used, reasonable images could not be obtained. The aspect ratio obtained was also strongly related in the same manner to the Component (A) content, and was additionally related to the specific compositions and ratios of Components (B) as well as the other Optional Components.

Crack resistance was found to be substantially improved by including larger amount of Component (B). The crack resistance was also improved by increasing the exposure dose. The larger the amount of Component (B) and the larger the dose the less the film would tend to crack. This behavior had to be balanced against the reduced resolution obtained in such films. It was found that compositions containing 20-50% of Component (B) gave the best combined performance of resolution, aspect ratio, cracking, adhesion, and flexibility. Inclusion of other optional ingredients such as (E), (F), and (H) could further improve upon these properties, but would not perform acceptably without Components (A) and (B). Comparison of the compositions at higher doses gave the same relative performance as when evaluated at the dose for best resolution, but the maximum attainable resolution was reduced to about the same degree for all samples.

TABLE 4
Summary of Lithographic Results

| | | Lithographic Performance | | | Lithographic Performance | | |
|---|---|---|---|---|---|---|---|
| | | At Dose To Size (6) | | | At Twice Dose To Size | | |
| | Film | Resolution | | | Resolution | | |
| | Thickness | Line/Space | Dose | Aspect | Line/Space | Dose | Aspect |
| Experiment | microns | microns | mJ/cm2 | Ratio | microns | mJ/cm2 | Ratio |
| Example 4⁽²⁾ | 30 | 9 | 112.5 | 3.3 | 9 | 225 | 3.3 |
| Example 5⁽⁵⁾ | 25 | 5 | 300 | 5 | 6 | 600 | 4.2 |
| Example 7⁽²⁾ | 30 | 9 | 137.5 | 3.3 | — | — | — |
| Example 10⁽¹⁾ | 50 | 7 | 280 | 7.1 | 13 | 560 | 3.8 |
| Example 11⁽¹⁾ | 50 | 7 | 250 | 7.1 | 11 | 500 | 4.5 |
| Example 12⁽¹⁾ | 50 | 7 | 150 | 7.1 | 7 | 300 | 7.1 |
| Example 13⁽³⁾ | 50 | 7 | 66 | 7.1 | 9 | 120 | 5.5 |
| Example 15⁽⁴⁾ | 50 | 7 | 66 | 7.1 | 9 | 120 | 5.5 |
| Example 17⁽³⁾ | 50 | 11 | 175 | 4.5 | — | — | — |
| Example 18⁽⁴⁾ | 50 | 7 | 145 | 7.1 | 14 | 270 | 3.6 |
| Example 30⁽⁴⁾ | 50 | 7 | 120 | 7.1 | 9 | 240 | 5.5 |
| Comparative | 30 | 6 | 120 | 5.0 | 7 | 200 | 4.3 |
| Example 1⁽²⁾ | | | | | | | |
| Comparative | 50 | 6 | 175 | 8.3 | 7 | 350 | 7.1 |
| Example 1⁽¹⁾ | | | | | | | |
| Comparative | 30 | >12 | — | — | — | — | — |
| Example 2⁽²⁾ | | | | | | | |

Numbers in parentheses in the Experiment column refer to the following process details:
⁽¹⁾Softbake: 65° C./1 min., 95° C./5 min; PEB: 65° C./1 min, 95° C./4 min
⁽²⁾Softbake: 65° C./1 min., 95° C./4 min; PEB: 65° C./1 min, 95° C./3 min
⁽³⁾Softbake: 65° C./1 min., 95° C./8 min; PEB: 65° C./1 min, 95° C./4 min
⁽⁴⁾Softbake: 65° C./2 min., 95° C./8 min; PEB: 65° C./1 min, 95° C./4 min
⁽⁵⁾Softbake: 65° C./1 min., 95° C./3 min; PEB: 65° C./1 min, 95° C./3 min
(6) Dose to size is defined as the exposure dose required to provide images with a 1:1 line to space pitch using an unbiased mask.

All samples exposed without a 320 nm cut-off filter and were developed in PGMEA and rinsed in IPA.

### Example 32

### Preparation and Processing of Dry Film Photoresist Composition

The composition of Example 19 (Table 2) containing approximately 55% solids was prepared as a dry film photoresist of approximately 15 μm thickness by coating the composition on Kapton film using the draw down method with a #20 Meyer rod mounted on an ACCU-LAB™ Auto-Draw III draw down coating machine (Industry Tech, Oldsmar, Fla.). The coated Kapton was dried in a mechanical convection oven at 100° C. for 15 minutes. The resulting dry film was then laminated onto a silicon wafer using a Dupont Riston® laminating machine operated at a roll temperature of 85° C., a roll pressure of 55 psi, and a roll speed of 0.3 meters per minute. After cooling for 2 minutes the Kapton film was peeled from the laminate leaving the photoresist composition on the silicon wafer. Next, the wafer was image-wise exposed at 100-800 mJ/cm² using a multistep transmission test mask designed by MicroChem Corp. on the AB-M, Inc. light source with an output power at 365 nm of 14.70 mW/cm². The wafer was then post exposure baked on hotplates for 1 minute at 65° C. and then for 4 minutes at 95° C., and then allowed to cool slowly. The wafer was then developed in propylene glycol monomethyl ether acetate (PGMEA) using a puddle develop process, rinsed with isopropanol and allowed to spin dry. The relief images were inspected in both top-down and in cross-section modes and were found to give the same lithographic characteristics as were observed for spin coated Example 16.

The following section describes the results of experiments performed on Examples 10, 15, 16, 18, 20 through 29 of the invention and on Comparative Examples 1, 5 and 6.

### Formulation of Examples 20 through 29 and Comparative Examples 5 and 6

Each component was mixed, dispersed, and blended in accordance with the compositions of Examples 20 through 29 and Comparative Examples 5 and 6 shown in Table 2 where the standard face numbers are parts by weight and the italic numbers are percentages of the total composition. The permanent photoresist compositions that were obtained were applied to silicon wafers at a thickness of 50 μm and dried for 20 minutes at 95° C. on a hot plate. Next, a negative mask was applied and the photoresist was irradiated with ultraviolet rays using a USH-500BY1light source (Ushio, Inc., Tokyo, Japan). After heat treatment for 10 minutes at 95° C. on a hot plate, the images were developed by immersing the wafers for 10 minutes in propylene glycol monomethyl ether acetate. The wafers were then rinsed with isopropyl alcohol and dried. As a final step, a heat treatment was performed for 30 minutes at 150° C. and then the following evaluations were performed.

Evaluation for Lithographic Performance

The aspect ratio of the pattern that was formed was determined by dividing the film thickness by the width of patterned feature according to Equation 1:
Aspect ratio=(film thickness)/(pattern width) Equation 1.

The lithographic patterning performance of Examples 21 through 30 and Comparative Examples 5 and 6 according the invention are summarized in Table 5 where performance is rated according to the following legend:
O=The formed pattern had an aspect ratio of 5 or higher.
X=The formed pattern had an aspect ratio of 2 or lower.
   Evaluation of Solvent Resistance

The cured film product of the photoresist composition was immersed for 30 minutes in acetone at room temperature and then peeling tests were performed to evaluate adhesion. The peeling tests involved applying cellophane tape to the photoresist cured film and then peeling the cellophane tape by pulling it from the coated wafer. Performance was evaluated according to the following criteria:
O=There were no anomalies in the external appearance of the cured photoresist film and there was no blistering or peeling.
P=There were almost no anomalies in the external appearance to the cured photoresist film and there was almost no blistering or peeling.
X=Extensive blistering and peeling of the cured photoresist film was observed.
   The solvent resistance test results are summarized in row 2 of Table 5.
   Evaluation Alkali Resistance

The photoresist (cured film) was immersed for 30 minutes in aqueous 5 wt % sodium hydroxide solution at room temperature and peeling tests were performed with cellophane tape. Alkali resistance was evaluated by the following criteria:
O=There were no anomalies in the external appearance of the cured photoresist film and there was no blistering or peeling.
P=There were almost no anomalies in the external appearance to the cured photoresist film and there was almost no blistering or peeling.
X=Extensive blistering and peeling of the cured photoresist film was observed.
   The alkali resistance test results are summarized in row 3 of Table 5.
   Evaluation of Acid Resistance

The photoresist (cured film) was immersed for 30 minutes in aqueous 10 wt % hydrochloric acid solution at room temperature and then peeling tests were performed with cellophane tape as described above. Acid resistance was evaluated by the following criteria:
O=There were no anomalies in the external appearance of the cured photoresist film and there was no blistering or peeling.
P=There were almost no anomalies in the external appearance to the cured photoresist film and there was almost no blistering or peeling.
X=Extensive blistering and peeling of the cured photoresist film was observed.
   The acid resistance test results are summarized in row 4 of Table 5.
   Evaluation of Heat Resistance

The photoresist cured film was heated for 10 seconds in an oven at 200° C. After cooling to room temperature, the photoresist was subjected to the same peeling tests with cellophane tape as described above. Heat resistance was evaluated by the following criteria:
O=There were no anomalies in the external appearance of the cured photoresist film and there was no blistering or peeling.
P=There were almost no anomalies in the external appearance to the cured photoresist film and there was almost no blistering or peeling.

X=Extensive blistering and peeling of the cured photoresist film was observed. The heat resistance test results are summarized in row 5 of Table 5.

TABLE 5
Evaluation Test Results

| | | | | | | | | | | | | | | | | | Comparative | | |
|---|---|---|---|---|---|---|---|---|---|---|---|---|---|---|---|---|---|---|---|
| | Examples | | | | | | | | | | | | | | | | Examples | | |
| Performance Property | 10 | 15 | 16 | 17 | 18 | 20 | 21 | 22 | 23 | 24 | 25 | 26 | 27 | 28 | 29 | 30 | 1 | 5 | 6 |
| Patterning performance¹ | O | O² | O | O | O | O | O | O | O | O | O | O | O | O | O | O | O | X | O |
| Solvent resistance | P | P³ | O | O | O | P | P | P | P | P | P | P | P | P | P | O | O | X | X |
| Alkali resistance | P | P³ | P | O | O | P | P | P | P | P | P | P | P | P | P | O | X | X | X |
| Acid resistance | P | P³ | P | O | O | P | P | P | P | P | P | P | P | P | P | O | X | X | O |
| Heat resistance | O | P³ | P | O | O | P | P | P | P | P | P | P | P | P | P | O | O | X | X |

¹Unless otherwise noted, all exposure were performed using a dose of 1000 mJ/cm² on the Ushio super high pressure mercury lamp source
²Exposed using AB-M source at a dose of 66 mJ/cm² as shown in Table 4.
³Exposed using Ushio super high pressure mercury lamp at a dose of 200 mJ/cm².

As is clear from the evaluation results in Table 5, the photoresist cured film obtained from the permanent photoresist composition of the present invention has excellent imaging performance and its cured product has excellent solvent resistance, alkali resistance, acid resistance, and heat resistance.

### Example 33

### Use of Organoaluminum Ion Gettering Agent (K)

A permanent photoresist composition was obtained by mixing 1 part by weight of aluminum triacetylacetonate (ALCMP) with 100 parts by weight of the photoresist composition in Example 21. A direct current of 100 V was applied to the permanent photoresist cured film obtained from this permanent photoresist composition under conditions of 90° C. and 90% RH. Insulation resistance after 500 hours was determined to be 10¹¹ Ω or higher.

### Example 34

### Compatibility With Ink Jet Printing Ink

The cured film of the photoresist composition of Example 21 was immersed in black ink for ink jet printers for 24 hours at 50° C. and then set aside. There were no anomalies in the external appearance of the film and no adhesion loss was observed.

### Example 35

### Strength and Toughness of Cured Film

The tensile strength of the cured film of the photoresist composition of Example 20 was 65 MPa, the modulus of elasticity was 1400 MPa, and the elongation-to-break was 10%.

### Example 36

### Transparency of Cured Film

The absorbance at 400 nm or higher of a 50 μm thick cured film of the photoresist composition of Example 20 was approximately 0.

### Example 37

### Formulation and Use as an E-Beam Photoresist

The composition of Example 18, 100 grams, was diluted with 40 grams of cyclopentanone. The resulting photoresist composition was applied to a thickness of 1 μm on a silicon wafer substrate. The wafer was then dried for 3 minutes at 95° C. The resulting film was irradiated at 5 μC/cm² at 30 kV beam energy using an ELS-3700 electron beam lithography system (ELIONOX Co., Ltd., Japan). Next, a heat treatment was performed for 5 minutes at 90° C. The heat treated wafer was immersed for 2 minutes in propylene glycol monomethyl ether acetate solvent and then rinsed with isopropyl alcohol. The resulting relief image showed resolution of 1 μm wide patterns.

As is clear from the evaluation results in Table 5 the permanent photoresist composition of the present invention has excellent patterning performance, and its cured product has excellent solvent resistance, alkali resistance, acid resistance, heat resistance, and electrical properties. Moreover, the permanent photoresist composition of the present invention can be used for a resin substrate, insulation layers, and dielectric layers because it has excellent insulation resistance, as shown by Example 33. The-photoresist compositions can be used for ink jet printer heads because it is resistant to the ink used in ink jet printers, as shown in Example 34. It can be used as a structural material for MEMS and micromachines because it has tensile strength, as shown in Example 35. It can be used for microreactors and μ-TAS because it has resistance to various solvents, acids and alkalies, as shown in Table 8. Further, it can be used as a photoconductive waveguide because it has excellent transmittance at 400 nm or higher, as shown in Example 36.

While the invention has been described above with reference to specific embodiments thereof, it is apparent that many changes, modifications, and variation can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety

1. A permanent photoresist composition comprising:
(A) one or more bisphenol A-novolac epoxy resins according to Formula I; 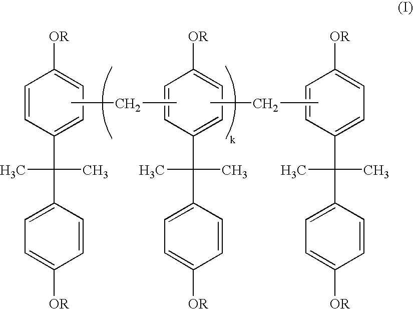
wherein each group R in Formula I is individually selected from glycidyl or hydrogen and k in Formula I is a real number ranging from 0 to about 30;
(B) one or more epoxy resins selected from the group represented by Formulas BIIa and BIIb; 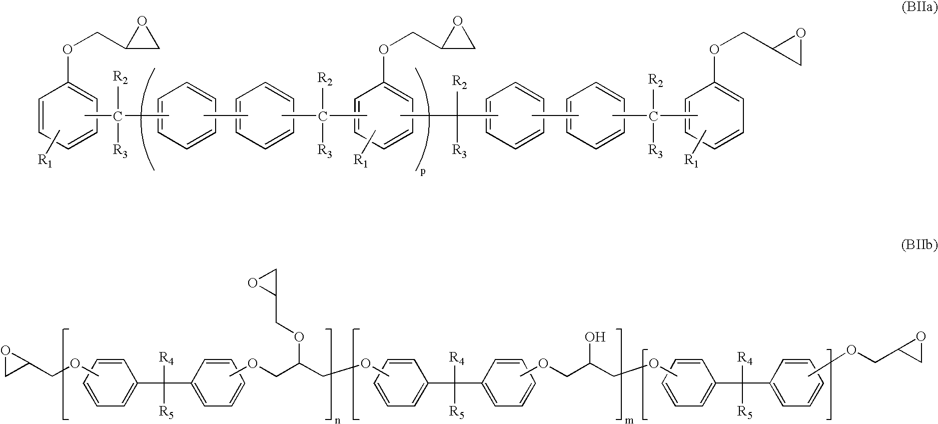
wherein each R₁, R₂ and R₃ in Formula BIIa are independently selected from the group consisting of hydrogen or alkyl groups having 1 to 4 carbon atoms and the value of p in Formula BIIa is a real number ranging from 1 to 30; the values of n and m in Formula BIIb are independently real numbers ranging from 1 to 30 and each R₄ and R₅ in Formula BIIb are independently selected from hydrogen, alkyl groups having 1 to 4 carbon atoms, or trifluoromethyl;
(C) one or more cationic photoinitiators (also known as photoacid generators or PAGs); and
(D) one or more solvents.

2. The composition according to claim 1 wherein the composition additionally contains one or more epoxy resins (E).

3. The composition according to claim 1 wherein the composition additionally contains one or more reactive monomers (F).

4. The composition according to claim 3 wherein the reactive monomer is selected from the group consisting of trimethylolpropane triglycidyl ether and polypropyleneglycol diglycidyl ether.

5. The composition according to claim 1 wherein the composition contains 0.1 to 10 weight percent of a cationic photoinitiator (C).

6. The composition according to claim 1 wherein the cationic photoinitiator is a mixture of arylsulfonium hexafluoroantimonate salts.

7. The composition according to claim 1 wherein the cationic photoinitiator is octylphenoxyphenyl iodonium hexafluoroantimonate.

8. The composition according to claim 1 wherein the composition additionally contains a photosensitizer compound (G).

9. The composition according to claim 8 wherein the photosensitizer is 2-ethyl-9.10-dimethoxyanthracene.

10. The permanent photoresist composition of claim 1 wherein the composition additionally contains one or more adhesion promoters (H).

11. The permanent photoresist composition according to claim 1 containing an organic aluminum compound (K).

12. A dry film photoresist composition made from the permanent photoresist compositions according to claim 1.

13. A method of forming a dry film photoresist composition comprising the process steps of: (1) applying the permanent photoresist composition of claim 1 to a polymer film substrate; (2) evaporating most of the solvent by heating the coated substrate to form a film of the photoresist composition on the polymer film substrate; and (3) applying a protective cover film to the surface of the permanent photoresist coating.

14. A method of forming a permanent photoresist pattern comprising the process steps of: (1) applying the photoresist composition of claim 1 to a substrate: (2) evaporating most of the solvent by heating the coated substrate to form a film of the composition on the substrate; (3) irradiating the coated substrate with active rays through a mask; (4) crosslinking the irradiated segments by heating: (5) developing the image with a with a solvent to form a relief image of the mask in the photoresist; and (6) optionally, crosslinking the developed relief image by heating.

15. A method of forming a permanent photoresist pattern using the dry film photoresist composition according to claim 12 comprising the process steps of: (1) laminating the dry film photoresist coating to the substrate; (2) removing the carrier film from the substrate; (3) irradiating the coated substrate with active rays through a mask; (4) crosslinking the irradiated segments by heating: (5) developing the image with a with a solvent to form a relief image of the mask in the photoresist; and (6) optionally crosslinking the developed relief image by heating.

16. The method of forming a photoresist pattern according to claim 14 where the active rays are ultraviolet rays, near infrared rays, X rays, or electron beam radiation.

17. The method of forming a photoresist pattern according to claim 15 where the active rays are ultraviolet rays, near infrared rays, X rays, or electron beam radiation.

18. A cured product formed from the permanent photoresist composition of claim 1.

19. A cured product of the dry film photoresist according to claim 12.

20. The cured product made according to claim 14 wherein the image aspect ratio is 1 to 100.

21. The cured product made according to claim 15 wherein the image aspect ratio is 1 to 100.

22. The cured product made according to claim 14 when it is used in the manufacture of electronic components, a microelectromechanical system, a μ-TAS part, or a microfluidic component or system.

23. The cured product made according to claim 15 when it is used in the manufacture of electronic components, a microelectromechanical system, a μ-TAS part, or a microfluidic component or system.

24. The cured product made according to claim 22, wherein the electronic component is a dielectric layer, insulation layer, photoconductive wave circuit, or resin substrate.

25. The cured product made according to claim 22, wherein the electronic component is an ink jet printer part.

26. A cured object according to claim 18 wherein the application is in the construction of parts for micro-electromechanical systems.

27. A cured object according to claim 18 wherein the application is in the fabrication of micro-TAS parts.

28. A cured object according to claim 18 wherein the application is in the fabrication of microchemical reactor parts.

29. The cured object according to claim 18 wherein the application is a dielectric layer.

30. The cured object according to claim 18 wherein the application is as an electrical or thermal insulator.

31. The cured object of claim 18 wherein the application is an optical wave guide material.

32. The cured object of claim 18 wherein the application is in the fabrication of ink jet print heads.

33. A cured object according to claim 19 wherein the application is in the construction of parts for micro-electromechanical systems.

34. A cured object according to claim 19 wherein the application is in the fabrication of micro-TAS parts.

35. A cured object according to claim 19 wherein the application is in the fabrication of microchemical reactor parts.

36. The cured object according to claim 19 wherein the application is a dielectric layer.

37. The cured object according to claim 19 wherein the application is as an electrical or thermal insulator.

38. The cured object of claim 19 wherein the application is an optical wave guide material.

39. The cured object of claim 19 wherein the application is in the fabrication of ink jet print heads.

40. A cured object according to claims 18 wherein the application is in the construction of array structures for biochemical analysis.

41. A cured object according to claims 18 wherein the application is in construction of cell growth platforms for biological materials.
